(19) United States
(12) Patent Application Publication
(10) Pub. No.: US 2011/0197423 A1
(43) Pub. Date: Aug. 18, 2011

(54) DEVICE AND METHOD FOR STORAGE TANK RESTRAINT ON A VEHICLE

(75) Inventors: Gregory A. Griffin, Glendale Heights, IL (US); Timothy Yoon, Northbrook, IL (US)

(73) Assignee: International Engine Intellectual Property Company, LLC, Warrenville, IL (US)

(21) Appl. No.: 13/014,472

(22) Filed: Jan. 26, 2011

Related U.S. Application Data
(60) Provisional application No. 61/305,652, filed on Feb. 18, 2010.

(51) Int. Cl. F16M 13/02; B23P 11/00

(52) U.S. Cl. 29/434; 248/220.22; 29/428

(57) ABSTRACT

A restraint device and method for securing an ammonia storage tank holder to a frame is disclosed. The restraint device includes first and second supports which sandwich about the holder in a parallel fashion. A connecting support attaches to and holds the first and second supports in a substantially parallel relationship about the storage tank holder, and is adjustable such that the second support is selectively movable to expand the perimeter of the holding space. The disclosed method includes the steps of affixing a first support having first and second ends to a frame of a vehicle, placing a storage tank holder into contact with at least one surface of the first support, placing a second support having first and second ends substantially parallel to the first support in contact with a surface of the storage tank holder opposite the first support, and securing the first and second supports.

### TECHNICAL FIELD OF THE INVENTION

The present device and method relate to a restraint device for a storage tank holder. Particularly, the device relates to a restraint device for securing a storage tank holder onto a vehicle frame.

### BACKGROUND OF THE INVENTION

Compression ignition engines provide advantages in fuel economy, but produce both NOₓ and particulates during normal operation. New and existing regulations continually challenge manufacturers to achieve good fuel economy and reduce the particulates and NOₓ emissions. Lean-burn engines achieve the fuel economy objective, but the high concentrations of oxygen in the exhaust of these engines yields significantly high concentrations of NOₓ as well. Accordingly, the use of NOₓ reducing exhaust treatment schemes are being employed in a growing number of systems.

One such system is the direct addition of ammonia gas to the exhaust stream. However, the ammonia addition method for controlling NOₓ requires onboard retention of ammonia (NH_{3 (solid)}) storage tanks.

The ammonia storage tanks or cartridges are elongated storage tanks having an elliptical or circular cross section. Such storage tanks are typically supported on the vehicle by a clamshell-type structure having one, two or even three cavities for the retention of multiple ammonia tanks or cartridges. The cartridge holder is most-often mounted to a frame of the vehicle and held closed to protect the tanks using a plurality of standard bolts. A drawback of the standard holder structure is that removing and replacing empty ammonia tanks is neither speedy nor simple due to the sometimes limited space for placement of the holder making access to the securing bolts very difficult. In some cases, only one end of the holder is readily accessible, requiring personnel to reach into small, tight spaces to attempt removal or insertion of the securing bolts.

The present invention overcomes these and other disadvantages of previous devices and processes. Disclosed is a system which is effective at both retaining a storage tank within a tank holder, and securing the holder onto a vehicle frame. The present invention also provides quick and easy access to the retained ammonia canisters for removal, repair, or inspection. The disclosed system is easy to use and relatively inexpensive to manufacture and install.

### SUMMARY OF THE INVENTION

There is disclosed herein a device, system and method, each of which avoids the disadvantages of prior devices, systems and methods while affording additional structural and operating advantages.

Generally speaking, a restraint device for securing an ammonia storage tank holder to a frame is comprised of first and second supports sandwiched about the holder in a parallel fashion. A connecting support is used to secure ends of the two supports together and thereby retain any enclosed ammonia storage cartridges.

In an embodiment, the first support has first and second ends, a first surface for contacting the storage tank holder during use, and a second surface fixedly attached to the frame, while the second support also has first and second ends and a first surface for contacting the storage tank holder during use. The connecting support attaches to and holds the first and second supports in a substantially parallel relationship about the storage tank holder, and is adjustable such that the second support is selectively movable to expand the perimeter of the holding space.

In an embodiment of the device, the connecting support is comprised of two separate parts. First, a hinge connector includes a first end pivotably attached to the first end of the first support and a second end pivotably attached to the first end of the second support. Second, a locking connector includes a first end attached to the second end of the first support and a second end attached to the second end of the second support. Preferably, the locking connector has an adjustable length.

In an embodiment of the system or assembly, an ammonia cartridge heating mantle assembly for attachment to the frame of a vehicle is set forth. Generally speaking, the assembly comprises a cartridge holder, a first support, a second support, a connecting support and a release mechanism attached to the connecting support.

In a specific embodiment of the assembly, the holder has first and second complementary portions to define an interior space, the portions aligning with one another at seams along peripheral edges. The interior space, of course, may be subdivided into a plurality of ammonia cartridge holding spaces.

The first support of the embodiment is fixedly attached to the frame of the vehicle and contacts the first complementary portion of the cartridge holder, while the second support is positioned across the second complementary portion of the cartridge holder opposite and parallel to the first support. The connecting support attaches to the first and second supports to form an open loop about the first and second complementary portions of the heating mantle, and the release allows the second support to move away from the cartridge holder to permit access to the interior space.

Finally, in the disclosed method, an embodiment for the retention of an ammonia storage tank on a vehicle comprises the steps of affixing a first support having first and second ends to a frame of a vehicle, placing a storage tank holder into contact with at least one surface of the first support, placing an ammonia storage tank into the storage tank holder, placing a second support having first and second ends substantially parallel to the first support in contact with a surface of the storage tank holder opposite the first support, securing the first end of the first support to the first end of the second support, and securing the second end of the first support to the second end of the second support.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of a typical three-cartridge holder secured to a vehicle;

FIG. 2 is a close-up of bolted joints from FIG. 1 showing the current method being used to secure ammonia tank holders to a vehicle;

FIG. 3 is a perspective view of an embodiment of the present invention;

FIG. 4 is a vertical cross-section of the embodiment shown in FIG. 3;

FIG. 5 is a longitudinal cross-section of the embodiment shown in FIG. 3;

FIG. 6 is a perspective view of another embodiment of the present invention; and

FIG. 7 is a perspective view of the embodiment of FIG. 6 attached to an ammonia tank holder.

### DETAILED DESCRIPTION OF THE INVENTION

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

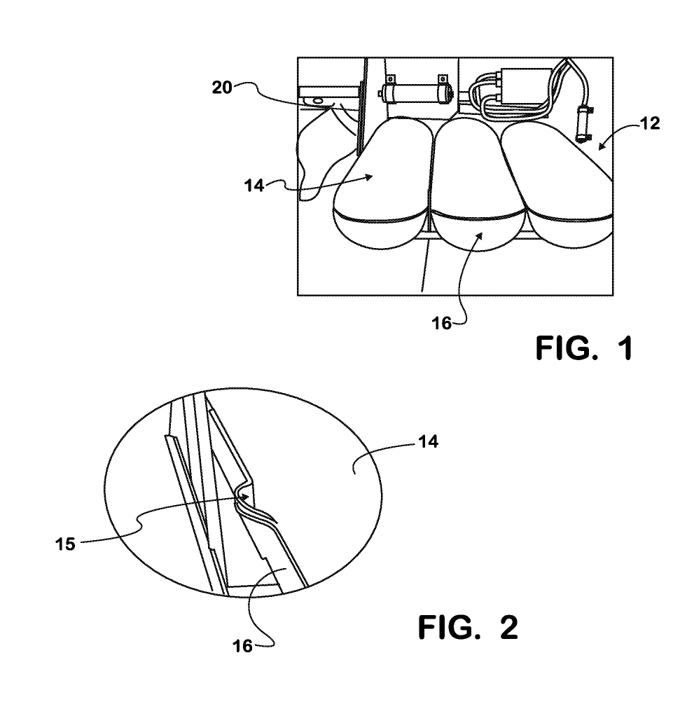

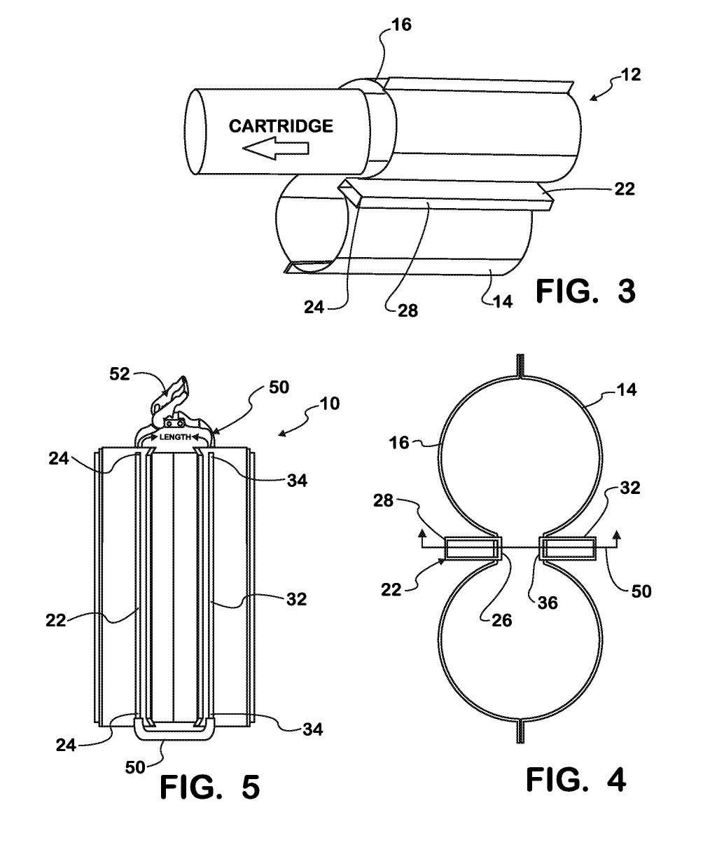

Referring to FIGS. 1-7, there is illustrated a restraint method and device for restraining a storage tank holder onto a vehicle frame. The restraint device of the present invention, generally designated by the numeral 10, is discussed with respect to a holder for ammonia storage tanks or cartridges, such as those used to supply ammonia gas to a combustion engine as a fuel-containing mixture. However, the particular holder may be used for retaining any type of suitable replaceable storage tank, including water tanks, air tanks, and the like.

FIGS. 1-3, illustrate current restraint device and methods for securing storage tanks within a holder 12. The holder 12 is typically comprised of two halves, an upper mantle 14 and a lower mantle 16. The holder 12 may be a heated or cooled container, as required by the particular material being stored within the retained tanks. For example, solid ammonia requires heating to sublimate the solid and form a usable ammonia gas.

The upper and lower mantles 14, 16 fit together to define an interior space where the tanks or cartridges may be retained. In the illustrated embodiment, the holder 12 has three separate compartments for retaining up to three suitable storage cartridges. The lower mantle 16 may be secured to a frame 20 of the vehicle, while the upper mantle 14 must remain removable—or at least hinged to the lower mantle—to allow changing of the storage tanks. The holder 12 may be oriented vertically or horizontally, so long as sufficient space is provided to remove the upper mantle 14 to allow insertion and removal of storage cartridges from the interior space. As shown, standard bolts 15 are used about the periphery of the upper mantle 14 to secure it to the lower mantle 16 after the desired number of storage tanks have been seated within the holder 12.

FIGS. 4-7 illustrate two alternate embodiments of the present restraint device 10. In either embodiment, the restraint device 10 is designed for securing an ammonia storage tank holder 12 to a vehicle frame. The device 10 comprises a first support 22 having first and second ends 24, a first surface 26 for contacting the storage tank holder 12 during use, and a second surface 28 fixedly attached to the frame (not shown). The device 10 also comprises a second support 32 having first and second ends 34 and a first surface 36 for contacting the storage tank holder 12 during use. As shown in the figures, the two supports 22, 32 are comprised of box-channel beams, having a rectangular cross-section with a hollow core. The supports 22, 32 may be made from a variety of preferably light, rigid materials, including metal, thermoplastic or some combination of the two. For most purposes, the first and second supports 22, 32 are structurally identical. In use, however, only the first support 22 is fixed to the vehicle frame. The first support 22 may be bolted or welded to the frame, as desired.

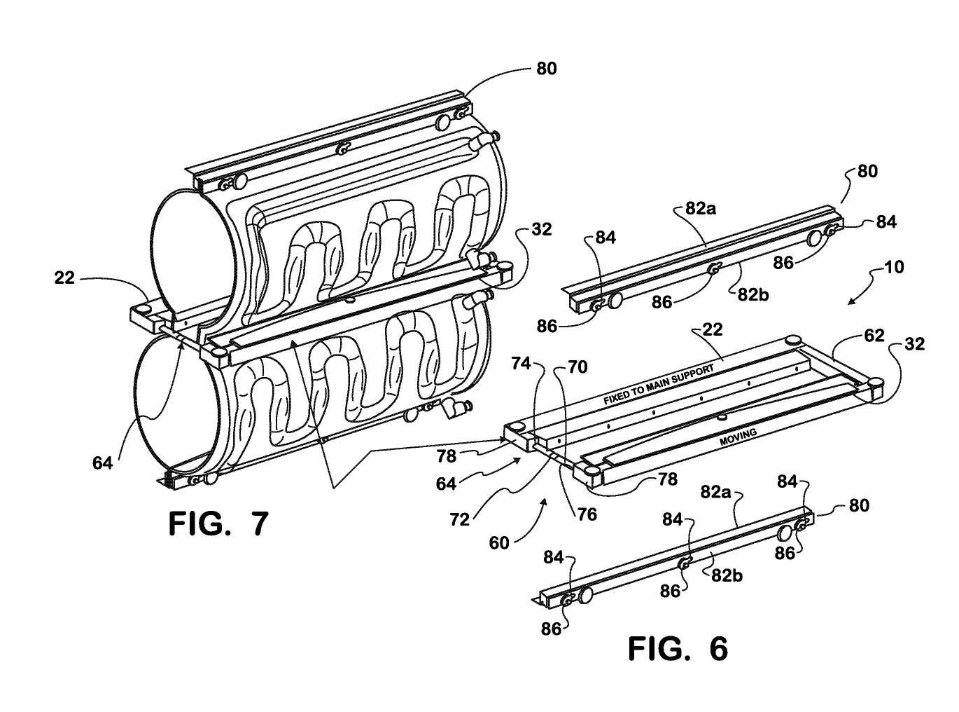

Another component common to both disclosed embodiments is a connecting support 42. The connecting support attaches to and is capable of holding the first and second supports 22, 32 in a substantially parallel relationship about the storage tank holder 12. The two distinct connecting supports are a flexible strap 50, shown in FIGS. 4 and 5, and a rigid connector assembly 60, shown in FIGS. 6 and 7.

With respect to the flexible strap 50, FIG. 5 illustrates the strap 50 being looped through the first support 22 and the second support 32. The holder 12 is placed in contact with the fixed first support 22 and then the second support 32 is positioned in a parallel relationship, as shown. The strap 50, which is comprised of a flexible material such as nylon or rubber, is fed through the open channel of the two supports. A buckle 52 or other locking member is used to hold the two ends of the strap 50 together. The buckle 52 may be merely a locking buckle having a clasp to lock the two joined ends in place, or the buckle may have a ratcheting mechanism to allow tightening of the strap 50. Both of these alternative configurations are known and understood by those of skill in the art. Importantly, as can be seen, the sandwiching of the holder 12 between the fixed first support 22 and the second support 32 results in retention of the holder to the vehicle frame (not shown).

In order to release the holder 12, the buckle 52 is opened or released and the strap 50 may be removed from the channel of the second support 32. The second support 32 may then be removed to allow the holder to be opened and/or removed.

Referring to the embodiment of FIGS. 6 and 7, a rigid connector assembly 60 is illustrated as the connecting support. The rigid connector assembly 60 includes a hinge connector 62 and a locking connector 64. The locking connector 64 is preferably a hex drive rod 70 having a center hexagonal-shaped knurl 72 and oppositely threaded ends, 74 and 76. The ends 74, 76 of the hex drive rod 70 threadably couple to fixed blocks 78 bolted or otherwise attached to the first ends of the first and second supports 22, 32. Accordingly, as the knurl 72 is turned in one direction, the threaded ends will either secure into or release from threaded openings on the fixed blocks 78.

The locking connector 64 has a first end attached to the second end of the first support 22 and a second end attached to the second end of the second support 32. Each of the attached ends is pivotably fastened to provide increased degrees-of-freedom to the second support 32 when uncoupled from the first support 22 at the first ends.

As shown in FIG. 7, a holding space for placement of the storage tank holder 12 is defined by a perimeter created by the first support 22, the second support 32 and the connecting support 42. The connecting support 42 is preferably adjustable such that the second support 32 can be selectively moved outward, for example, to expand the perimeter of the holding space. This can be used to accommodate holders of different sizes.

Where multiple compartments are presented by the holder, additional edge flange clamping members 80 may be used. The clamping members 80 employ two bars 82 secured to one another by a plurality of slots and tabs. One bar 82a includes a series of keyhole slots 84, while the other bar 82b has corresponding locking tabs 86 which fit into the circular opening of the keyhole slot 84 and then lock tight within the slot. This tab and slot configuration for holding two components together is well-known by those skilled in the art.

In use, the embodiments of the present retention device 10 may attached to a vehicle by affixing, in any suitable manner, the first support 22 to a portion of the vehicle frame (not shown). If the intended holder is suited for holding more than two storage cartridges, it may be necessary to affix more than one first support 22 to the vehicle frame—i.e., use more than one restraint device 10. Once the requisite number of supports are affixed, a storage tank holder can be placed into contact with at least one surface of the first support(s) 22. If necessary, at this time an ammonia storage tank(s) or other tank(s), can be placed into the storage tank holder for retention. A second support 32 is then placed parallel to each corresponding first support 22 and in contact with a surface of the storage tank holder 12 opposite the corresponding first support 22. Each set of first and second support 22, 32 is secured at each end, using either the flexible strap 50 or the rigid connector assembly 60 discussed above.

Once assembled to the vehicle, a ratcheting buckle 52, if used, on the flexible strap 50 or the hex drive 70 of the rigid connector assembly 60 may be used to tighten the restraint device 10 about the holder 12. Additional clamping members 80 may also be added to secure the holder 12 closed.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A restraint device for securing an ammonia storage tank holder to a frame, the device comprising:
a first support having first and second ends, a first surface for contacting the storage tank holder during use, and a second surface fixedly attached to the frame,
a second support having first and second ends and a first surface for contacting the storage tank holder during use,
a connecting support attached to and capable of holding the first and second supports in a substantially parallel relationship about the storage tank holder, and
a holding space for placement of the storage tank holder, the holding space having a perimeter defined by the first support, the second support and the connecting support,
wherein the connecting support is adjustable such that the second support is selectively movable to expand the perimeter of the holding space.

2. The restraint device of claim 1, wherein the connecting support comprises:
a hinge connector having a first end pivotably attached to the first end of the first support and a second end pivotably attached to the first end of the second support, and
a locking connector having a first end attached to the second end of the first support and a second end attached to the second end of the second support.

3. The restraint device of claim 2, wherein the locking connector has an adjustable length.

4. The restraint device of claim 2, wherein the locking connector is detachable from at least one of either the first support or the second support.

5. The restraint device of claim 3, wherein the locking connector has left-hand threads on one of either the first or second end and right-hand threads on the other end.

6. The restraint device of claim 2, wherein the locking connector comprises a hex drive.

7. The restraint device of claim 1, wherein the first and second supports comprise box-channel rails.

8. The restraint device of claim 7, wherein the connecting support comprises a flexible strap and the strap passes through the channel rails.

9. The restraint device of claim 8, wherein the flexible strap is comprised of nylon.

10. The restraint device of claim 9, wherein the nylon strap comprises a buckle.

11. The assembly of claim 10, wherein the buckle comprises a ratcheting buckle.

12. An ammonia cartridge heating mantle assembly for attachment to the frame of a vehicle, the assembly comprising:
a cartridge holder having first and second complementary portions to define an interior space, the portions aligning with one another at seams along peripheral edges;
a first support fixedly attached to the frame of the vehicle and contacting the first complementary portion of the cartridge holder;
a second support positioned across the second complementary portion of the cartridge holder opposite and parallel to the first support;
a connecting support attached to the first and second supports to form an open loop about the first and second complementary portions of the heating mantle; and
a release attached to the connecting support to allow the second support to move away from the cartridge holder to permit access to the interior space.

13. The assembly of claim 12, wherein the connecting support comprises:
a hinge connector having a first end pivotably attached to a first end of the first support and a second end pivotably attached to a first end of the second support, and
a locking connector having a first end attached to a second end of the first support and a second end attached to a second end of the second support.

14. The assembly of claim 13, wherein the locking connector has an adjustable length.

15. The assembly of claim 13, wherein the locking connector is detachable from at least one of either the first support or the second support.

16. The assembly of claim 14, wherein the locking connector has left-hand threads on one of either the first or second end and right-hand threads on the other end.

17. The assembly of claim 13, wherein the locking connector comprises a hex drive.

18. The assembly of claim 12, wherein the first and second supports comprise box-channel rails.

19. The assembly of claim 18, wherein the connecting support comprises a flexible strap and the strap passes through the channel rails.

20. The assembly of claim 19, wherein the flexible strap is comprised of nylon.

21. The assembly of claim 20, wherein the nylon strap comprises a buckle.

22. The assembly of claim 21, wherein the buckle comprises a ratcheting mechanism to allow adjustment of the connecting support.

23. A method for the retention of an ammonia storage tank on a vehicle, the method comprising the steps of:
affixing a first support having first and second ends to a frame of a vehicle;
placing a storage tank holder into contact with at least one surface of the first support;
placing an ammonia storage tank into the storage tank holder;
placing a second support having first and second ends substantially parallel to the first support in contact with a surface of the storage tank holder opposite the first support;
securing the first end of the first support to the first end of the second support; and
securing the second end of the first support to the second end of the second support.

24. The method of claim 23, wherein the step of securing the first ends of the supports comprises the step of attaching a connecting support to the first ends.

25. The method of claim 23, wherein the step of securing the second ends of the supports comprises the step of attaching a connecting support to the second ends.

26. The method of claim 24, wherein the connecting support comprises a hinge connector having a first end pivotably attached to a first end of the first support and a second end pivotably attached to a first end of the second support.

27. The method of claim 25, wherein the connecting support comprises a locking connector having a first end attached to a second end of the first support and a second end attached to a second end of the second support.

28. The method of claim 23, wherein the steps of securing the first ends of the supports and securing the second ends of the supports comprises the step of attaching a connecting support having first and second ends through the first and second supports and connecting the first and second ends of the connecting support to one another.

29. The method of claim 28, wherein the connecting support is a flexible strap.

30. The method of claim 29, wherein the flexible strap comprises a ratcheting buckle.
